(19) United States
(12) Patent Application Publication
(10) Pub. No.: US 2007/0012618 A1
(43) Pub. Date: Jan. 18, 2007

(54) Microporous filter

(76) Inventor: Edward J. Swenson, Portland, OR (US)

Correspondence Address: STOEL RIVES LLP, 900 SW FIFTH AVENUE, SUITE 2600, PORTLAND, OR, 97204-1268, US

(21) Appl. No.: 11/525,555

(22) Filed: Sep. 22, 2006

Related U.S. Application Data
(62) Division of application No. 10/931,440, filed on Aug. 31, 2004.
(60) Provisional application No. 60/512,007, filed on Oct. 15, 2003.
(60) Provisional application No. 60/542,626, filed on Feb. 6, 2004.

(51) Int. Cl. B01D 71/06

(52) U.S. Cl. 210/500.27; 210/512.1; 210/500.36; 96/4

(57) ABSTRACT

A laser-based drilling technique provides a microporous filter having very small holes with known diameters and locations. One embodiment of the technique entails using a laser beam with one or more uniform spot sizes to form each hole. The laser beam ablates material depthwise for corresponding known distances into a substrate to form a desired number of hole steps in each hole. Another embodiment of the technique entails using an imprint patterning toolfoil to stamp in the substrate depressions of specified diameters and distances that correspond to the hole steps. In both embodiments, a laser beam of Gaussian shape removes the last portion of material to form a very small diameter final hole step.

### RELATED APPLICATIONS

This application is a division of U.S. patent application Ser. No. 10/931,440, filed Aug. 31, 2004, which claims benefit of U.S. Provisional Patent Application Ser. No. 60/512,007, filed Oct. 15, 2003, and U.S. Provisional Patent Application Ser. No. 60/542,626, filed Feb. 6, 2004.

### TECHNICAL FIELD

This disclosure relates to microporous filters and, in particular, to a microporous filter having small diameter holes of reliable sizes and in known locations.

### BACKGROUND INFORMATION

Microporous filters are currently made of inherently slightly porous materials such as woven cotton fibers, paper, and woven synthetic fabric. Such filters find applications in the manufacture of pharmaceutical drugs; in industrial fuel cells; and in separating body fluids, chemical particles, and different materials for analysis. The sizes and locations of the holes forming the filter pores vary with the filter material structure.

What is needed is a microporous filter formed of very small, predictable diameter holes placed in known locations and therefore arranged in a known population density.

### SUMMARY OF THE DISCLOSURE

Preferred embodiments of a laser-based drilling technique entail forming in a substrate an array of stepped holes, each of which having a very small, predictable final diameter in a known location. The array includes a final hole step, which is formed by a laser of an ultraviolet (UV) wavelength, which is shorter than 400 nm. The remaining hole step or steps of the array are formed by use of a laser or an imprint patterning technique. The final hole step diameter and population density of the holes define the porosity of the microporous filter formed from the membrane.

In a first preferred embodiment, a UV laser emitting either 355 nm or 266 nm light ablates material from, to form a hole through, a polymer-based, flexible membrane, such as polyimide, polycarbonate, or polytetrafluoroethylene (PTFE). The UV laser ablates and therefore breaks the chemical bonds of the organic material to form holes of final or exit diameters of between about 1.0 μm and about 5.0 μm in a membrane material of between about 50 μm and about 250 μm in thickness. (This compares to 20 μm-100 μm holes formed in 200 μm thick organic packaging materials.) The holes are formed in steps of decreasing diameters depthwise through the thickness of the membrane to give a desired aspect ratio to reduce plasma and debris effects that would inhibit or prevent formation of a large aspect ratio, small diameter hole. A large aspect ratio hole is one in which the ratio of its length to width is greater than 5:1. This technique is accomplished by changing the spot size of the laser beam as it ablates the target material depthwise and allows the escape of plasma gases and debris produced during the ablation process. Gases and debris trapped at the bottom of a large aspect ratio hole interferes with the process of drilling a small diameter final hole step.

Stepped holes are advantageous because they cause a reduced drop in pressure that enables passage of material of the desired size through the final, smallest diameter hole.

In a second preferred embodiment, an imprint patterning toolfoil, which is a sheet of metal with an array of protruding features, is pushed into the flexible membrane to form in it an array of depressions. The UV laser forms the final hole step through the bottom of each of multiple depressions in the array. Imprint patterning opens up the region around the intended hole location and thereby permits the escape of gases and debris. This allows the formation of a small aspect ratio final hole step.

The central axes of the stepped holes need not be perpendicular to the upper and lower major surfaces of the membrane. Angled holes may be advantageous to enable filtering particles composed of helical molecular structures of different rotational senses.

Additional aspects and advantages of this invention will be apparent from the following detailed description of preferred embodiments, which proceeds with reference to the accompanying drawings.

### BRIEF DESCRIPTION OF THE DRAWINGS

FIG. 1 is an enlarged fragmentary cross sectional view of a microporous filter having a stepped hole formed with its central axis disposed perpendicular to the upper and lower major surfaces of a flexible polymeric membrane.

FIG. 2 is an enlarged fragmentary cross sectional view of an alternative microporous filter having a stepped hole formed with its central axis inclined at a nonperpendicular tilt angle relative to the upper and lower major surfaces of a flexible polymeric membrane.

FIGS. 3 and 4 are enlarged fragmentary views of toolfoils containing patterns of cylindrical protrusions having, respectively, uniform diameters and lengthwise sections of different diameters.

### DETAILED DESCRIPTION OF PREFERRED EMBODIMENTS

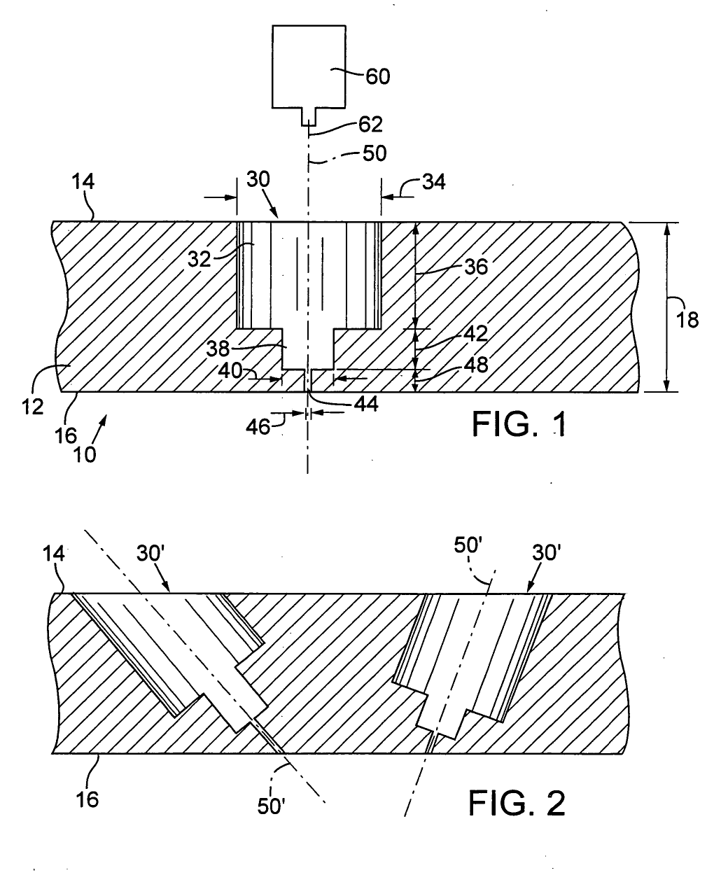

FIG. 1 shows a cross sectional view of a microporous filter 10 formed of a flexible polymeric membrane 12 having an upper major surface 14 and a lower major surface 16 that are generally parallel and define between them a membrane thickness 18. Polymeric membrane 12 is preferably formed of polyimide, polycarbonate, PTFE, or other organic membrane material. The porosity of filter 10 is accomplished by formation of a number of stepped holes 30 (only one hole shown in FIG. 1) passing in a depthwise direction through membrane thickness 18 to form the filter pores. Preferred embodiments of filter 10 are fabricated with holes 30 formed with two or more hole steps. The following is a description of a preferred hole 30 formed with three hole steps of progressively decreasing sizes, i.e., cross sectional areas measured parallel to upper and lower major surfaces 14 and 16. Because in preferred embodiments holes 30 can be of either circular or elliptical shape in cross section, for the sake of convenience, a hole size is referred to herein by its major axis dimension.

Preferred hole 30 has an overall length of about 100 μm, which is defined by membrane thickness 18. A typical membrane thickness 18 and therefore hole length ranges between 50 μm and 250 μm. Hole 30 is formed with an entrance hole step 32 having a width 34 of about 40 μm and a depth 36 of about 70 μm, an intermediate hole step 38 having a width 40 of about 15 μm and a depth 42 of about 25 μm, and an exit hole step 44 having a width 46 of between about 1 μm and about 5 μm and a depth 48 of about 5 μm. Hole 30 has a central axis 50 to which hole steps 32 and 38 need not be axially aligned, depending on their respective widths 34 and 40 and concomitant need to span width 46 of hole step 44.

FIG. 2 shows two angled holes 30′, which are the same as hole 30 with the exception that the central axes 50′ of holes 30′ are inclined at nonperpendicular angles relative to upper and lower major surfaces 14 and 16.

The use of a laser beam is a first preferred method of forming holes 30. FIG. 1 shows a laser 60 emitting a beam 62 that propagates along a propagation path that is collinear with central axis 50. Laser 60 preferably emits ultraviolet (UV) light, which represents light of wavelengths shorter than 400 nm, with 355 nm and 266 nm being preferred. A programmable lens system (not shown) optically associated with laser 60 accomplishes setting the spot size of beam 62 to establish the major axis dimensions of hole steps 32, 38, and 44. A power level controller (not shown) adjusts the power of beam 62 to a level that is appropriate to the sizes of the hole steps being formed, the power used to form hole step 38 being less than that used to form hole step 32. A beam 62 of uniform shape is preferably used to form hole steps 32 and 38, and a beam 62 of Gaussian shape is preferably used to form hole step 44.

The capability of providing beam 62 of the desired shapes, spot sizes, and power levels to form hole 30 exists in currently available equipment. For example, hole steps 32 and 38 can be formed by a laser beam produced by a Model 5330 Via Drilling System, and hole step 44 can be formed by a laser beam produced by a Model 4420 Micromachining System, both of which are manufactured by Electro Scientific Industries, Inc., Portland, Oreg., which is the assignee of this patent application. The Model 5330 produces a UV laser beam of uniform shape, and the Model 4420 produces a UV laser beam of Gaussian shape with a very small spot size.

### EXAMPLE

An array of through holes, each of which having two hole steps, was formed in a 200 μm thick polycarbonate membrane as follows. A 355 nm laser output propagating through a 2× beam expander formed for each hole in the polycarbonate membrane a circular first hole step having a 50 μm diameter and a 180 μm-190 μm depth. The laser beam had a uniform power profile with a 220 mW level at 2 kHz Q-switch rate. A workpiece positioner operating at a 60 mm/sec scan speed moved the laser beam relative to the membrane to repetitively, sequentially scan the hole locations. During the sequential scanning process, the laser beam removed from the hole locations depth-wise portions of membrane material to partly form the first hole steps. The sequential partial removal of portions of membrane material allowed the plasma gases created during the hole step drilling process to escape and thereby ensure formation of high-quality holes. Several iterations of the scanning process sequence were carried out to complete formation of the first hole steps. Skilled persons will appreciate that laser processing parameters can be selected to achieve complete formation of a hole step without return trips to a partly drilled hole step.

The 355 nm laser output propagating through a 20× Gaussian lens formed through the bottom surface of the first hole step of each hole in the array an exit hole step having 5 μm diameter and a 10 μm-20 μm depth. An exit hole step was formed at each hole location by consecutive application of a pulsed laser beam to effect a hole punching operation. Ten pulses of either a 600 mW or a 950 mW Gaussian-shaped laser beam pulsed at 10 kHz formed in the array of holes exit hole steps of repeatable high quality.

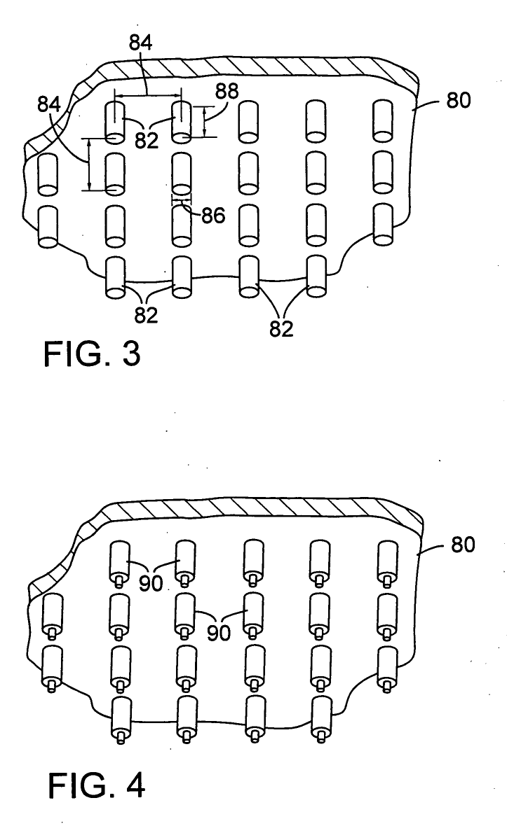

The use of an imprint patterning toolfoil in combination with a laser beam is a second preferred method of forming holes 30. FIG. 3 is an enlarged fragmentary view of a metal toolfoil 80 containing a pattern formed by a regular array of nominally identical cylindrical protrusions 82 mutually spaced apart by a predetermined distance 84. Protrusions 82 form hole steps in membrane 12 in accordance with an imprint patterning technique. This is accomplished by positioning toolfoil 80 and membrane 12 in a conventional laminating press (not shown) and operating it to urge protrusions 82 into upper major surface 14 and thereby stamp complementary depressions in membrane 12. Protrusions 82 are of specified diameters 86 and lengths 88 that correspond to, respectively, the major axis (diameter) dimension and depth of the hole step. In FIG. 1, the depressions correspond to either of hole steps 32 or hole steps 38. Laser beam 62 of Gaussian shape is preferably used to form the exit hole step, such as hole step 44 in FIG. 1.

Although protrusions 82 of FIG. 3 are of uniform diameters, FIG. 4 shows protrusions 90 configured to have lengthwise sections of different major axis dimensions or diameters can be used to form in one laminating cycle multiple hole steps in each hole of membrane 12. Because multiple stepped holes of decreasing major axis dimensions are used in part to prevent plasma effects stemming from use of laser 60, the use of imprint patterning eliminates the need for multiple-step depression or hole formation before laser ablation of the exit hole step.

It will be obvious to those having skill in the art that many changes may be made to the details of the above-described embodiments without departing from the underlying principles of the invention. For example, polymeric membrane 12 can be composed of two laminated sheets in which an upper sheet is perforated with larger diameter hole steps and a lower sheet is perforated with smaller diameter, laser-drilled exit hole steps. The scope of the present invention should, therefore, be determined only by the following claims.

1. A microporous filter, comprising:
a flexible polymeric membrane having first and second generally parallel major surfaces that define between them a membrane thickness; and
a number of holes passing in a depthwise direction through the membrane thickness to form pores of the membrane, each of the number of holes configured in multiple steps of decreasing major axis dimensions from the first major surface to the second major surface.

2. The microporous filter of claim 1, in which each of the number of holes includes first and second hole steps having respective first and second major axes, the first hole step being formed through the first major surface and the second hole step being formed through the second major surface, and the first major axis being greater than the second major axis.

3. The microporous filter of claim 2, further comprising an intermediate hole step positioned between the first and second hole steps of each of the number of holes, the intermediate hole step having a major axis that is less than the first major axis and greater than the second major axis.

4. The microporous filter of claim 3, in which the first, second, and intermediate hole steps have respective first, second, and intermediate depths, the intermediate depth being less than the first depth and greater than the second depth.

5. The microporous filter of claim 1, in which each of the number of holes includes a central axis that extends through the membrane thickness, the central axis inclined at a nonperpendicular tilt angle relative to the first and second major surfaces.

6. The microporous filter of claim 1, in which the membrane is formed of an organic material.

7. The microporous filter of claim 6, in which the organic material includes one of polyimide, polycarbonate, or PTFE.
